(19) United States
(12) Patent Application Publication
(10) Pub. No.: US 2023/0369650 A1
(43) Pub. Date: Nov. 16, 2023

(54) ELECTROLYTE COMPOSITIONS FOR USE IN ELECTROCHEMICAL CELLS AND ELECTROCHEMICAL CELLS MADE THEREFROM

(71) Applicant: Purdue Research Foundation, West Lafayette, IN (US)

(72) Inventors: Vilas Ganpat Pol, West Lafayette, IN (US); Soohwan Kim, Lafayette, IN (US)

(21) Appl. No.: 18/197,674

(22) Filed: May 15, 2023

Related U.S. Application Data
(60) Provisional application No. 63/342,580, filed on May 16, 2022.

(51) Int. Cl. H01M 10/0568; H01M 10/0569; H01M 4/583; H01M 4/38; H01M 4/525; H01M 4/505; H01M 50/417; H01M 4/485

(52) U.S. Cl. CPC H01M 10/0568; H01M 10/0569; H01M 4/583; H01M 4/382; H01M 4/525; H01M 4/505; H01M 50/417; H01M 4/485; H01M 2004/027

(57) ABSTRACT

An electrolyte composition for use is in an electrochemical cell. The electrolyte contains 5 M lithium bis(fluorosulfonyl) imide (LiFSI) dissolved in tetrahydrofuran (THF), wherein the electrolyte composition has ion-aggregates dominant solvation structures by introducing larger amounts of FSI anions than found with conventional solid electrolytes, resulting in an interfacial layer between anode and electrolyte of an electrochemical cell utilizing the electrolyte composition, less resistive than an interfacial layer between an anode and a conventional solid electrolyte in an electrochemical cell. Also disclosed is an electrolyte containing Lithium bis(fluorosulfonyl) imide (LiFSI) salt dissolved in tetrahydrofuran (THF), fluoroethylene carbonate (FEC), 1,1,2,2-Tetrafluoroethyl 2,2,3,3-tetrafluoropropyl ether wherein the electrolyte is capable of being used in an electrochemical cell at −80° C. and lower. Electrochemical cells containing these electrolytes, with cathode-electrolyte and capable of combination is rechargeable up to −80° C. and lower.

### CROSS-REFERENCE TO RELATED APPLICATIONS

The present U.S. patent application is related to and claims the priority benefit of U.S. Provisional Patent Application Ser. No. 63/342,580, filed May 16, 2022, the contents of which are hereby incorporated by reference in their entirety into the present disclosure.

### STATEMENT REGARDING GOVERNMENT FUNDING

This invention was made with government support under N00014-21-1-2070 awarded by the U.S. Navy Office of Naval Research. The government has certain rights in the invention.

### TECHNICAL FIELD

The present disclosure generally relates to electrolyte compositions for use in electrochemical cells, especially in Li-ion batteries, and especially for improved performance at ultra-low temperature (of the order of −40° C.) lithium-ion battery cycling.

### BACKGROUND

This section introduces aspects that may help facilitate a better understanding of the disclosure. Accordingly, these statements are to be read in this light and are not to be understood as admissions about what is or is not prior art.

The reference numerals appearing in parentheses and/or superscripts throughout this specification refer to references for the respective information being conveyed in that sentence. Those references are listed in the numerical order towards the end of this specification.

Lithium-ion batteries (LIBs) are a focal point of economic growth in major developed countries due to their high energy and power densities, low self-discharge rate, and widespread application, including portable electronics and electric vehicles. Nevertheless, the poor performance of conventional LIB technologies at low temperatures remains a barrier to utilization in applications like submarines, unmanned aerial vehicles, and space exploration. The main challenges of low temperature LIB operation result from (i) the low ionic conductivity, and possible salt precipitation that occurs in contemporary electrolytes at subzero temperatures, (ii) the high desolvation barrier for Li⁺ originated from the high charge transfer resistance at the electrode-electrolyte interface, including solid electrolyte interphase (SEI) layer, and (iii) the high melting point of typical carbonate-based electrolyte solvent. Notably, all of these issues are strongly associated with the electrolyte, which serves as both the ion transport medium and seed for SEI formation⁸⁻¹⁰, and several of these problems are intrinsic to the high melting point of typical carbonate solvents^{3,4}. These factors suggest that for low temperature operation, the carbonate electrolyte paradigm needs to be abandoned for alternative solvents and salt combinations that are designed specifically for low temperature operation. For developing a post-carbonate low temperature electrolyte, however, a particularly challenging issue has been that the SEI layer formed by alternative solvents (e.g., ethers, nitriles, and sulfones) displayed limited stability. Therefore, state-of-the-art LIBs heavily rely on the secondary heating system for low temperature operation, while the electrolytes are still composed of a carbonate solvents mixture with 1 to 1.3M of lithium hexafluorophosphate (LiPF₆) salt because of its excellent SEI formation ability.

Hence there is an unmet need for modification of the internal chemistry of the battery to improve the cycling performance of batteries described above at lower temperatures than room temperatures.

### SUMMARY

An electrolyte composition for use is in an electrochemical cell is disclosed. The electrolyte contains 5 M lithium bis(fluorosulfonyl) imide (LiFSI) dissolved in tetrahydrofuran (THF), wherein the electrolyte composition has ion-aggregates dominant solvation structures by introducing larger amounts of FSI anions than found with conventional solid electrolytes, resulting in a thin, inorganic-rich, interfacial layer between anode and electrolyte of an electrochemical cell utilizing the electrolyte composition, wherein the thin, inorganic-rich, interfacial layer has resistance less than resistance of an interfacial layer between an anode and a conventional solid electrolyte in an electrochemical cell employing the anode and the conventional solid electrolyte.

An electrochemical cell is disclosed. The electrochemical cell contains an anode comprising graphite; a cathode comprising one of Li metal, LiNi_{0.6} Co_{0.2}Mn_{0.2}O₂; a separator; and an electrolyte comprising LiFSI dissolved in THF, wherein the electrolyte has ion-aggregates dominant solvation structures by introducing larger amounts of FSI anions.

An electrolyte composition for use is in an electrochemical cell is disclosed. The electrolyte contains Lithium bis(fluorosulfonyl) imide (LiFSI) salt dissolved in tetrahydrofuran (THF), fluoroethylene carbonate (FEC), 1,1,2,2-Tetrafluoroethyl 2,2,3,3-tetrafluoropropyl ether wherein the electrolyte is capable of being used in an electrochemical cell at −80° C. and lower.

An electrochemical cell is disclosed. The electrochemical cell contains: an anode comprising Li metal; a cathode containing Niobium tungsten oxide; a separator; and an electrolyte comprising LiFSI dissolved in THF, FEC, and 1,1,2,2-Tetrafluoroethyl 2,2,3,3-tetrafluoropropyl ether, wherein the electrolyte-cathode combination is rechargeable up to −80° C. and lower.

### BRIEF DESCRIPTION OF DRAWINGS

While some of the figures shown herein may have been generated from scaled drawings or from image that are scalable, it is understood that such relative scaling within a figure are by way of example, and are not to be construed as limiting.

FIG. 1A through DIG. 1C show solvation structure depending on salt concentration FIG. 1A: a Raman spectrum of electrolytes in the range of 990-1070 cm⁻¹ (C—O—C vibrational mode of THF); FIG. 1B: 700-780 cm⁻¹ (S—N—S vibrational mode of FSI⁻) Deconvoluted spectra of FSI⁻ anions in the solvation. FIG. 1C: c Distribution of the Li⁺ solvates from Raman spectra.)

FIG. 2A through FIG. 2J show SEI morphology and chemistry arising from unique solvation structure. (HRTEM images of the cycled graphite electrode particles (CVE FIG. 2A, HSCE in FIG. 2B; Overlapped STEM/EDS images of the cycled graphite electrode particles for CVE and HSC are FIGS. 2C and 2D respectively. FIGS. E through FIG. 1 show C 1s, O 1s, F 1s, N 1s, and S 2p XPS spectra respectively for the cycled graphite electrodes surface. FIG. 2J is a Schematic illustration of the solvation structure and SEI layer on graphite electrode surface.

FIG. 3A through FIG. 3E show electrochemical performance of graphite half-cells. (FIG. 3A shows galvanostatic voltage profiles for the first cycle at 0.1 C (36 mA g⁻¹) and room temperature (RT); FIG. 3B shows cyclic voltammetry curves of graphite electrodes in HSCE and LSCE; FIG. 3C shows Cycling performance at 0.5 C (186 mA g⁻¹) and RT. FIG. 3D shows low temperature cycling performance at 0° C., −20° C., and FIG. 3E shows low-temperature cycling performance at −40° C.)

FIG. 4A through FIG. 4F show Li⁺ kinetics at the interfacial region and graphite electrodes. Temperature dependent EIS Nyquist plots of graphite electrodes are shown in FIG. 4A and FIG. 4B for CVE and HSCE respectively. Impedance-derived Arrhenius plots for activation energies corresponding to Li⁺ transport through SEI layer are shown in FIG. 4C and those for Li⁺ desolvation process are shown in FIG. 4D. FIG. 4E shows Voltage hysteresis, ohmic polarization, and FIG. 4F Li⁺ diffusion coefficient based on GITT measurement.

FIG. 5A through FIG. 5D shows electrochemical performance of LiNi_{0.6} Co_{0.2}Mn_{0.2}O₂∥Graphite full cells. FIG. 5A shows galvanostatic voltage profiles for the first cycle; FIG. 5B shows cycling performance at 0.2 C (36 mA g⁻¹) and room temperature (RT).

FIG. 5C shows low temperature galvanostatic voltage profiles; FIG. 5D shows cycling performance at −20° C. and −40° C.

FIG. 6A and FIG. 6B shows Pseudocapacitive Li⁺ storage behavior evaluation. FIG. 6A shows Cyclic voltammetry (CV) curves under different scan rates ranging from 0.05 to 2.0 mV/s and FIG. 6B shows Current versus scan rate (log(iₚ) vs. log(v)) plots the peaks in CV curves.

FIGS. 7A and 7B show Electrochemical performance of Niobium tungsten oxide (NbWO). FIG. 7A shows room-temperature rate capability at various current rates (1 C=149.3 mA g⁻¹) and FIG. 7B shows galvanostatic voltage profiles at various low temperatures.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates.

Despite the essential role of ethylene carbonate (EC) in solid electrolyte interphase (SEI) formation, the high Li⁺ desolvation barrier and melting point (36° C.) of EC impedes lithium-ion battery operation at low temperatures and induces sluggish Li⁺ reaction kinetics. In this disclosure is demonstrated an EC-free high salt concentration electrolyte (HSCE) composed of lithium bis(fluorosulfonyl)imide salt and tetrahydrofuran solvent with enhanced subzero temperature operation originating from the low melting of tetrahydrofuran (−109° C.) and enhanced Li⁺ transport. Experimental results leading to this disclosure reveal the dominance of intra-aggregate solvation structure in HSCE. In this disclosure, it is shown that the electrolyte produces a thin anion-derived LiF-rich SEI layer with excellent graphite electrode compatibility and electrochemical performance at subzero temperature in half-cells. Also shown in this disclosure is the compatibility of the electrolyte of this disclosure with LiNi_{0.6} Co_{0.2}Mn_{0.2}O₂ graphite full-cells outperforming the conventional EC electrolyte during charge-discharge operation at an extreme temperature of −40° C.

A high salt concentration strategy enabled exploration of an electrolyte that does not contain carbonate solvents due to its unusual type of SEI formation. Increasing the salt concentration causes anions to participate in the Li⁺ solvation structure mainly by deprivation of solvent molecules that otherwise coordinate with Li⁺. In addition to the normally occurring solvent separated ion pairs and contact ion pairs (CIPs) in diluted electrolytes, the presence of larger aggregates (AGGs) of ions with potentially dynamic membership has a significant role in the physicochemical and interfacial properties of the electrolytes. This extensive coordination of anions leads to lowering the electron energy level of anions to the lowest unoccupied molecular orbital (LUMO) of the electrolytes. Therefore, high salt concentration electrolytes (HSCEs) produce the SEI layer by anion decomposition, unlike the typical EC-based electrolytes which form the SEI layer by decomposition of solvent molecules. This distinct SEI structure of the HSCEs not only showed its robustness during the LIBs operation in various electrolyte solvents, but also enhanced electrochemical properties like increased energy density, long-term cyclability, and fast-charging ability. Moreover, the multitude of solvent options that are made possible with the HSCEs can help overcome the challenges faced by EC or other carbonate solvents for subzero temperature operation.

In this disclosure is described a novel HSCE for a low temperature LIB electrolyte made by a mixture of tetrahydrofuran (THF) solvent and lithium bis(fluorosulfonyl)imide (LiFSI) salt. The high concentration strategy enables us to reconsider THF as a LIB electrolyte, which previously showed promising results with titanium disulfide electrode for low temperature application but exhibited poor compatibility with the graphite electrode in the LIBs. The combination of THF and LiFSI provide physicochemical properties that are favorable for constituting an HSCE and facilitating the repeated charge-discharge of the LIBs at low temperature. THF as a solvent has physical properties that are beneficial for developing an HSCE aimed at low temperature operation, such as low melting point (−109° C.) and low viscosity, in addition to the adequate dielectric constant for dissolving lithium salts. Furthermore, the chemical stability of THF is superior to other ether solvents with similar physical properties such as 1,3-dioxolane, which is prone to ring-opening reaction and polymerization due to the two ether oxygen in its structure. On the other hand, LiFSI provides additional advantages for Li⁺ transport in low temperature LIBs. For example, the large anion size of LiFSI can minimize the undesirable increase in viscosity at high concentration. Also, FSI⁻ decomposition creates a LiF-rich SEI layer along with other inorganic compounds such as Li₂O, Li₂S, and Li₃N, which is beneficial for facile Li⁺ transfer reactions in the LIB interfaces.

In this work, we demonstrate that the electrolyte combination provides an extended subzero temperature window for repeated charge-discharge cycling of the LIBs, which originates from its unique solvation and SEI structures. Experimental analyses confirmed AGG dominant Li⁺ solvation structure. Additionally, the resulting anion-derived SEI layer was thinner than most conventional SEI layers and enriched with LiF along with other inorganic species on the graphite electrode. The AGG rich solvation structure and SEI layer led to excellent compatibility with the graphite electrode, showing enhanced electrochemical performance for graphite half-cells at room and subzero temperature. Evaluation of Li⁺ kinetics by electrochemical methods reinforced the notion that the enhancement can be attributed to the kinetically favorable solvation and SEI structure along with the low melting point of THF solvent. Moreover, the enhanced low temperature charge-discharge performance was effective for the LiNi_{0.6} Co_{0.2}Mn_{0.2}O₂ (NCM622)∥graphite full-cells as retaining 80% (at −20° C.) and 43% (at −40° C.) of the room temperature capacity.

In experiments leading to this disclosure, the following materials, methods, and measurements were employed.

Materials: Electrolytes were prepared by dissolving a given amount of lithium bis(fluorosulfonyl)imide (LiFSI, TCI America) salts into solvents in an Ar-filled glove box. Tetrahydrofuran (THF) was purchased from Sigma-Aldrich. All reagents were high purity (>98%) and used without further purification. A conventional electrolyte for comparison is composed of 1.0 M LiPF₆ in a mixture of ethylene carbonate (EC) and diethyl carbonate (DEC) (Sigma-Aldrich, 1:1 v/v, battery grade).

Structural characterization: Coordination structures of solutions were identified by a Raman microscope (Thermo Scientific DXR 2) with a 613 nm laser. TEM analyses and EDS chemical mapping were carried out on a transmission electron microscope (Thermo Scientific FEI Talos 200X) operated at 200 kV equipped with a high angle annular dark field (HAADF) detector and SuperX EDS with four silicon drift detectors. All the EDS maps were captured under the drift correction mode. Surface chemistries of graphite electrodes were investigated by an X-ray photoelectron spectrometer (Kratos AXIS Ultra) equipped with a monochromatized Al—Kα X-ray source. The electrodes were cycled 10 times for SEI formation and washed with dimethyl carbonate (DMC) in the Ar-filled glove box to remove residual electrolyte components before TEM and XPS analyses.

Electrochemical measurements: The graphite electrodes containing mesocarbon microbeads (MCMB) graphite (91.83 wt %) as an active material, C45 (2 wt %) as a conductive agent, polyvinylidene difluoride (PVDF) (6 wt %) as a binder, and oxalic acid (0.17 wt %) as an additive were prepared onto Cu foil with a mass loading of 6.2-6.3 mg cm⁻² (CAMP Facility at Argonne National Laboratory (ANL)). Half-cells were assembled using CR2032 coin-type cells with lithium metal as a counter electrode, a polypropylene membrane (Celgard 2500) as a separator and the prepared electrolytes in the Ar-filled glove box. The half-cell galvanostatic charge/discharge measurement was carried out using a battery-testing system (Arbin BT-2000) at a voltage range of 0.01 to 1.5 V versus Li/Li⁺. Charging (lithiation) was performed in a constant current-constant voltage mode and discharging (dilithiation) was performed in a constant current mode. To determine cycling stability at room temperature, the half-cells were cycled at 0.5 C-rate (1 C=372 mA g⁻¹). For low temperature performance tests, the half-cells were charged and discharged with the following C-rate at several temperatures (0.1 C/0.2 C for 0° C., 0.1 C/0.1 C for −20° C., and 0.05 C/0.05 C for −40° C.). Formation cycles were given for the cells at 0.1 C-rate for 5 cycles before all cycling tests. Rate capability tests were carried out with different current rates (0.2 C to 10 C) at room temperature.

Cyclic voltammetry (CV), electrochemical impedance spectroscopy (EIS), and linear sweep voltammetry (LSV) measurements were carried out using a potentiostat (Gamry Reference 600+). The CV tests for the graphite half-cells were conducted in the potential range between 0.01 and 1.5 V (vs. Li/Li⁺) at a scan rate of 0.1 mV s⁻¹. The EIS for the half-cells were performed over a frequency range of 1 MHz to 10 mHz with 10 mV amplitude of AC voltage perturbation at several temperatures (15-35° C.). Before the EIS, the half-cells were cycled at 0.1 C for 5 cycles to complete SEI formation and held at 0.15 V until the current reaches 0.01 C, which is the characteristic Li⁺ intercalation potential of the graphites. The LSV was conducted with Al working electrode and Li reference and counter electrode, sweeping from open circuit potential to 5.5 V at a rate of 0.5 mV s⁻¹. Galvanostatic intermittent titration technique (GITT) measurement for the half-cells was performed using the battery-testing system (Arbin BT-2000) with 0.2 C of pulse current density for 0.5 hour followed by 2 hours of equilibration time.

For coin-type full-cells, the stated graphite and LiNi_{0.6} Co_{0.2}Mn_{0.2}O₂ (NCM622) electrodes were employed with N/P ratio (capacity ratio of negative to positive electrode) of 1.30-1.35. The NCM622 electrodes composed of NCM622 (90 wt %) as an active material, C45 (5 wt %) as a conductive agent, and PVDF (5 wt %) as a binder were coated on Al foil with a mass loading of 9.4-9.7 mg cm⁻² (CAMP Facility at ANL). The full-cells were fabricated employing CR2032 coin-type cells with a polypropylene membrane (Celgard 2500 membrane) as a separator and the prepared electrolytes in the Ar-filled glove box. For galvanostatic charge-discharge tests of the coin-type full-cells, the cells were charged using constant current-constant voltage mode and discharged using constant current mode within the voltage range of 2.7 to 4.2 V. The cells were charged and discharged with the following C-rate (1 C=180 mA g⁻¹) at several temperatures (0.2 C/0.2 C for room temperature, 0.05 C/0.05 C for −20° C., and 0.025 C/0.025 C for −40° C.). Formation cycles were carried out for the cells at 0.2 C-rate for 5 cycles at room temperature before low temperatures (−20° C. and −40° C.) full-cell cycling tests.

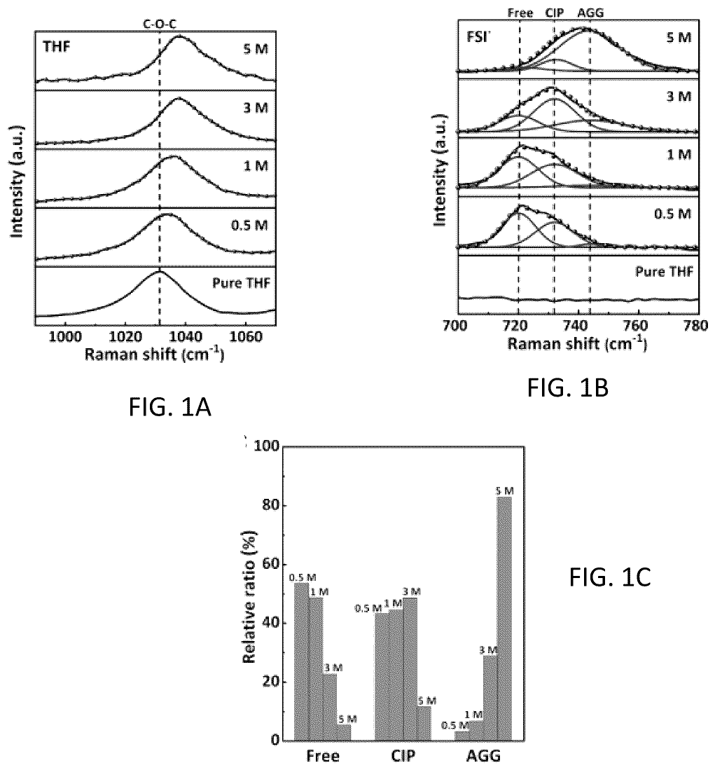

Experimental aspects of solvation structures of this disclosure: The solvation structure of electrolytes at various lithium salt concentrations were investigated by Raman spectroscopy. The peaks appearing at 990-1070 cm⁻¹ denote C—O—C vibrational mode (1031 cm⁻¹) of THF solvent (FIG. 1A). As the salt concentration is increased from 0 to 5 M, there is a gradual upward shift in this peak position. This shift is due to the growth of Lit-solvent coordination which shortens the C—O bond in the THF solvent and increases the vibration frequency of this mode³². It represents that more solvent molecules engage in the solvation structure with the increased salt content. FIG. 1B shows the Raman spectra between 700-780 cm⁻¹ mainly originated from S—N—S vibrational mode of FSI. Three peaks located at 720, 732 and 744 cm⁻¹ represent the free FSI⁻ (non-coordinated FSI⁻), CIPs (FSI⁻ coordinating with one Lit), and AGGs (FSI⁻ coordinating with two or more Li⁺ forming an ion pair domain over large distance), respectively. With the increasing salt concentration from 0.5 to 5 M, the peaks representing non-coordinated FSI⁻ decreased, while the peaks belonging to those of CIPs and AGGs increased simultaneously. The ratio of these individual constituents shows that CIPs and AGGs occupied most of the solvation structure at 5 M where the majority is AGGs (FIG. 1C). The Raman spectra observations provided us with a clear picture of the increasing participation of anions in the solvation structure.

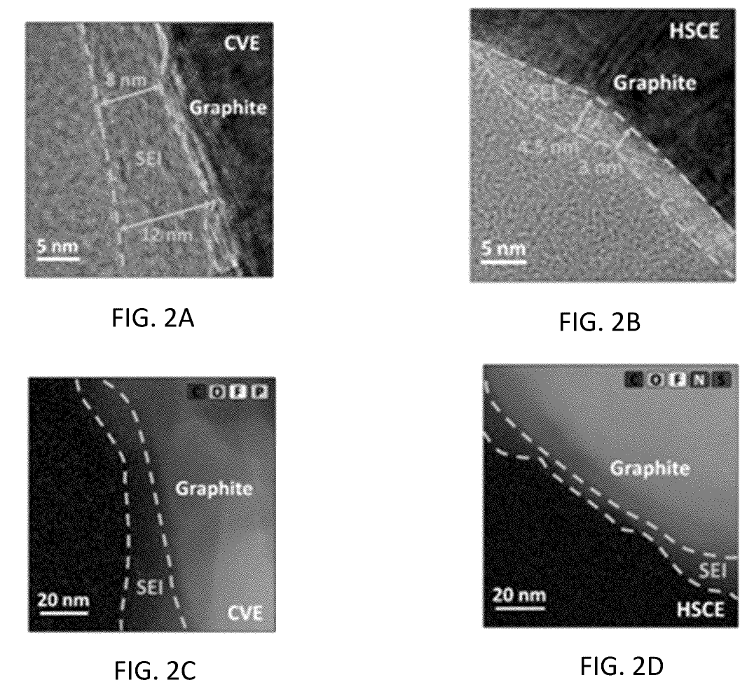

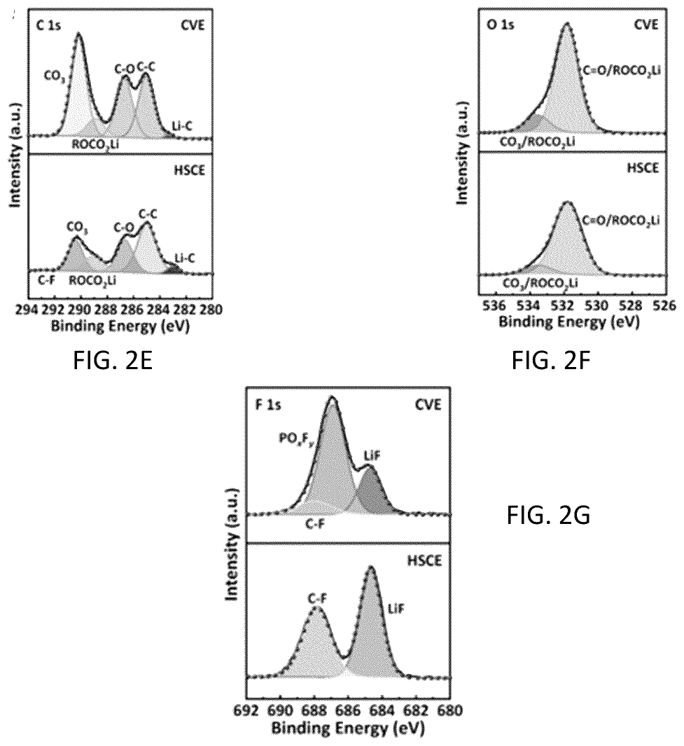

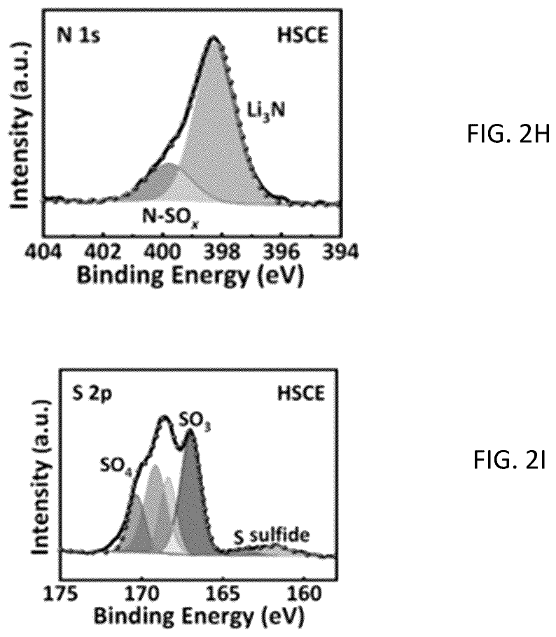

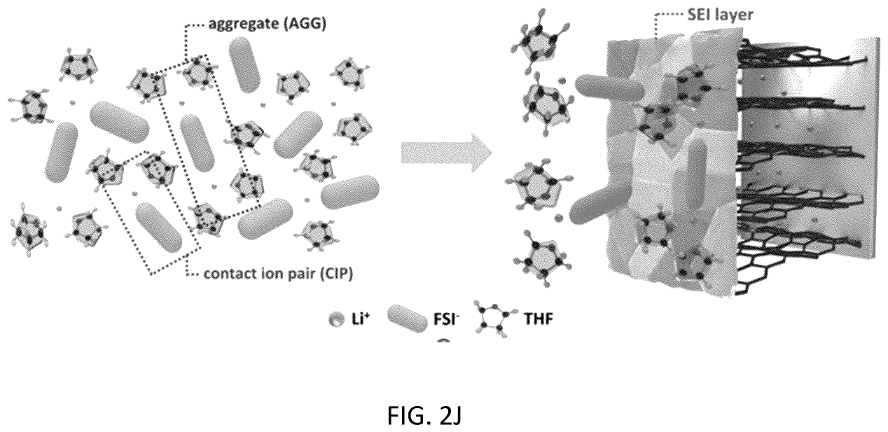

Favorable SEI layer structure: Transmission electron microscopy (TEM) images provided the morphology of SEI layer on the surface of cycled graphite electrode particles in conventional electrolyte (CVE, 1M LiPF₆ EC/DEC (1:1, v/v)) and high salt concentration electrolyte (HSCE, 5M LiFSI THF). As seen in a high-resolution TEM (HRTEM) image, 8 to 12 nm thick SEI layer covers the graphite electrode particles when cycled in the CVE (FIG. 2A). On the other hand, the HSCE forms a much thinner SEI layer of 3 to 4.5 nm around graphite electrode particles (FIG. 2B). This difference in SEI layer formation mechanism results from the modified solvation structure at high concentration of salt in the HSCE. The energy-dispersive X-ray spectroscopy (EDS) mapping obtained using scanning transmission electron microscopy (STEM) further confirms the thin SEI layer formation with 5 M LiFSI (FIGS. 2 C and 2D). Although only carbon and oxygen intensities are apparent in the EDS images, the strong oxygen intensities at the interfacial layers demonstrate the formation of SEI layer at those regions since the SEI formation process produced several organic and inorganic compounds containing oxygen through electrolyte decomposition.

X-ray photoelectron spectroscopy (XPS) analysis reveals the composition of SEI layer formed from the CVE and HSCE. The C 1s and O 1s spectra show similar peak positions for both electrolytes (FIGS. 1D and 1E). The atomic ratio and peak area ratio for organic species (C—O, ROCO₂Li, and CO₃) decreased in the HSCE for both C 1s and O 1s spectra which suggests suppressed solvent decomposition on the surface compared to that of the CVE. In the F is spectra, increased atomic ratio and the relatively higher content of LiF in the HSCE indicate that the modified solvation structure induced decomposition of FSI⁻ and abundant LiF formation on the graphite electrode surface (FIG. 1F). Furthermore, the N 1s and S 2p spectra of the HSCE show formation of other inorganic species such as Li₃N and Li₂S from the FSI⁻ decomposition which are absent in the spectra for the CVE (FIGS. 1G and 1H). Overall, XPS spectra suggest that FSI⁻ decomposition from the HSCE brought a SEI layer containing inorganic species with larger amounts of LiF, whereas organic species mostly occupy the SEI layer composition in the CVE.

FIG. 2J illustrates the resulting solvation structure and SEI layer on graphitic anode surface for the HSCE. The key feature of the HSCE is the extensive coordination of FSI⁻ around the Li⁺ in the form of AGGs, as confirmed from Raman spectroscopy. The dominance of AGG structures is known to substitute the solvent molecules with anions in the LUMO of the electrolyte, which in turn facilitates the decomposition of anions instead of solvent molecules. Consequently, these effects produced a thinner and anion-derived SEI layer effectively, composed of rich LiF with other inorganic compounds such as Li₂O, Li₂S, and Li₃N. The thin SEI layer can give lower resistance for Li⁺ diffusion and electron transfer. LiF-rich with other inorganic compounds in the SEI layer can also provide improved stability and rapid reaction kinetics at the interface region.

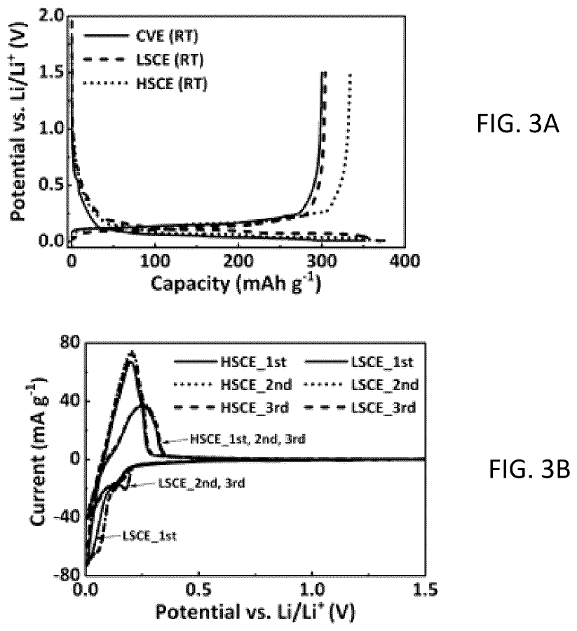

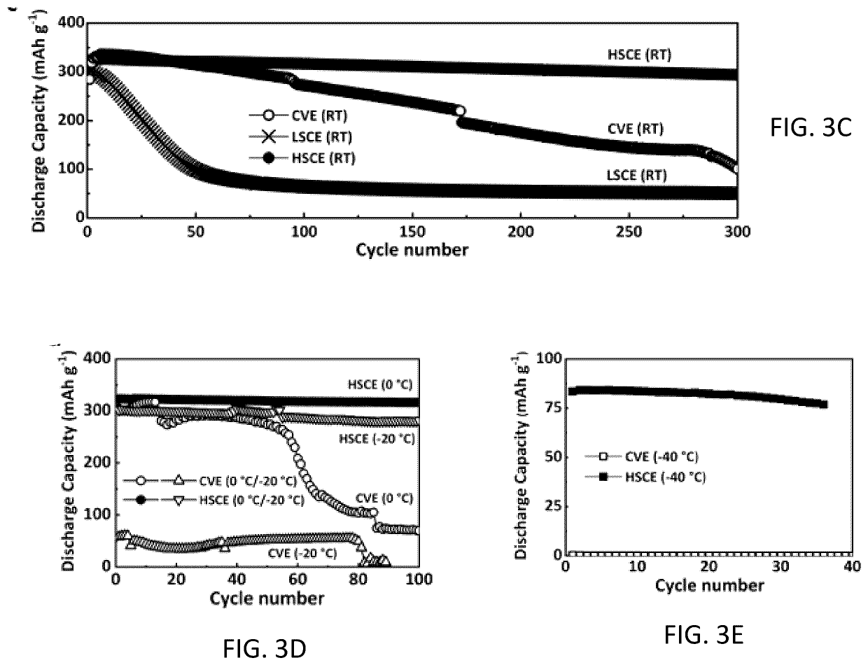

Compatibility of the HSCE with the graphite electrode: To confirm the compatibility of the HSCE in LIB, we performed electrochemical tests at room temperature through galvanostatic cycling and cyclic voltammetry. The first cycle voltage profile of the graphite half-cells presents reversible Li⁺ reactions irrespective of the electrolytes used (FIG. 3A). The graphite electrode in the CVE showed highly reversible Li⁺ intercalation/deintercalation with a small peak around 0.55 V during intercalation indicating solvent decomposition and the corresponding SEI layer formation. However, there are no evident peaks around 0.55 V for the graphite electrodes in the THF-based low salt concentration electrolyte (LSCE, 1 M LiFSI in THF) and HSCE, which revealed different electrolyte decomposition behavior in them. Nonetheless, they showed stable charge-discharge behavior with the graphite electrodes at the first cycle with three voltage plateaus between 0.05-0.25 V. These plateaus indicate that both the LSCE and HSCE performed as well as the CVE at the first cycle through three different stages of Li⁺ intercalation process.

However, cyclic voltammograms of the graphite electrodes exhibit different behavior between the LSCE and HSCE (FIG. 3B). A new peak occurred around 0.05 V during a cathodic scan in curves of the LSCE after the first cycle. Considering ethers decompose at 0.0-0.3V³⁹, this peak originated from the decomposition of THF due to abundant non-coordinated THF molecules at low concentrations. This peak appeared repeatedly after the first cycle because decomposition of ethers continuously happened by not being able to form a robust SEI layer on the graphitic anode surface, which eventually can lead to reversible capacity loss^{8,11}. Unlike the LSCE, the overlapped redox curves for HSCE demonstrated excellent reversibility of Li⁺ reactions. The HSCE also showed a small peak at 1.14 V during a cathodic scan at the first cycle which indicated FSI⁻ decomposition to form the SEI layer, whereas solvent decomposition occurred in the LSCE (0.05 V) and CVE (0.6 V). The effects of such behavior became clearer in the long-term cycling tests. The discharge capacities of the graphite electrode in the LSCE continuously decayed after the first cycle and reached 30% of initial capacity before 60 cycles (FIG. 3C). On the other hand, the graphite electrodes in the CVE and HSCE showed stable performance over 100 cycles with stable Coulombic efficiencies (CE, discharge capacity/charge capacity %) (FIG. 3C). Moreover, the electrode in the HSCE maintained 90% of capacity retention over 300 cycles (FIG. 3C).

The above results showed that a THF-based electrolyte with low salt concentration cannot create a robust SEI layer and causes continuous solvent decomposition, which resulted in the repetitive loss of reversible capacity. However, the HSCE enabled the graphite electrode to operate stably and even achieved superiority over the CVE regarding long-term cycling performance, due to the modified Li⁺ solvation structure and resultant thinner but robust anion-derived SEI layer.

Enhanced performance at subzero temperatures: In addition to the great compatibility with the graphite electrode, the developed HSCE enhanced the performance of cells at extreme conditions. The low temperature cycling tests of the graphite electrodes in different electrolytes revealed the enhanced electrochemical performance of the HSCE at all temperatures. At 0° C., the discharge capacity of the graphite electrode with the HSCE (323 mAh g⁻¹) was almost the same as the capacity at room temperature and maintained over 100 cycles (FIG. 3D). On the other hand, the graphite electrode using the CVE did not show comparable performance and capacity dropped fast after 50 cycles. Furthermore, even at −20° C., the graphite electrode using the HSCE could deliver a capacity of over 300 mAh g⁻¹, whereas only 59 mAh g⁻¹ capacity was delivered and faded further in the CVE (FIG. 3D). As the temperature dropped to −40° C., the graphite electrode using the HSCE was still able to deliver 84 mAh g⁻¹ (FIG. 3E). Although the capacity at −40° C. was lower than that of 0° C. or −20° C., its performance was much better than that of the graphite electrode with the CVE, which has negligible electrochemical energy output. The low melting point of THF broadened the operating temperature window and led to the enhancement.

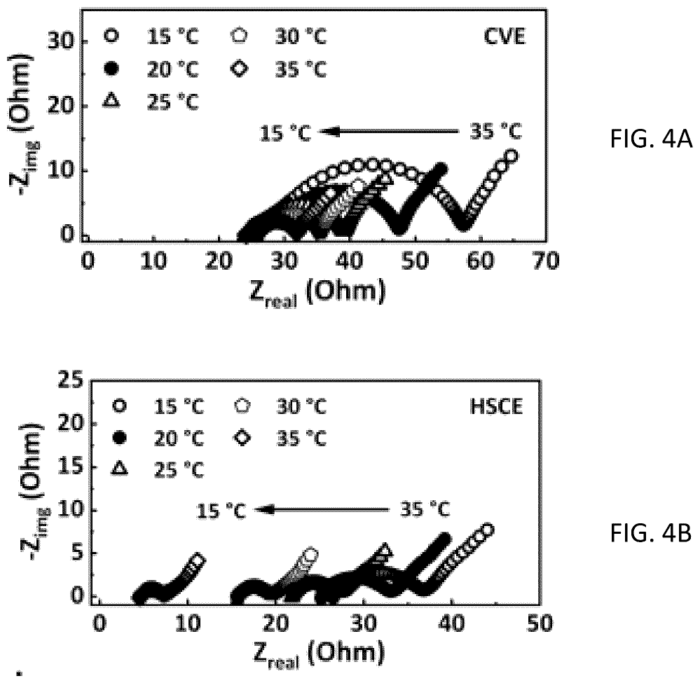

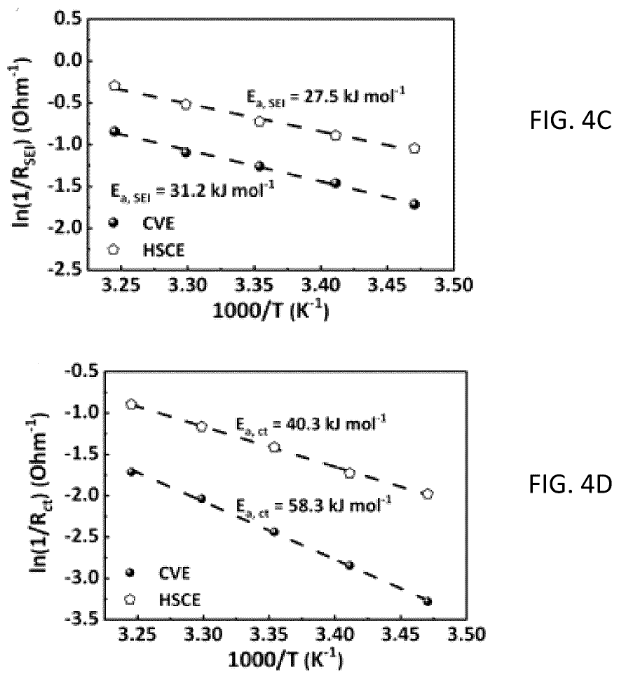

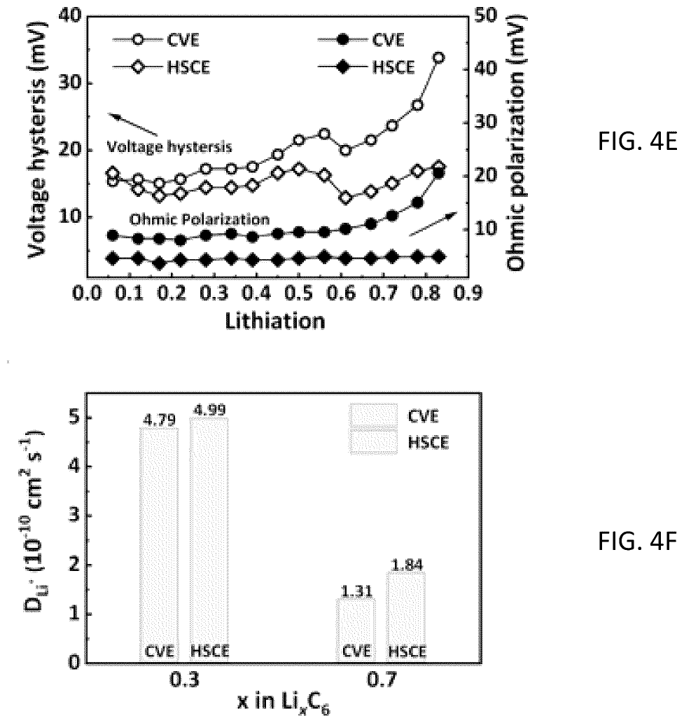

To find the source of the improved low temperature performance of the HSCE besides the low melting point of THF solvent, we further examined Li⁺ kinetics at the interfacial region and bulk graphite electrodes electrochemically. Temperature-dependent electrochemical impedance spectroscopy (EIS) shows enhanced Li⁺ transport kinetics at the interfacial region of the graphite electrode in the HSCE. In the Nyquist plots, the high-frequency region represents Li⁺ transport through the SEI layer and the mid-frequency region indicates the Li⁺ desolvation process (charge-transfer at Li⁺ intercalation voltage) based on the well-established studies (FIGS. 4A and 4B). The resistance values are calculated by fitting the Nyquist plot using an equivalent circuit. Arrhenius plots from these figures and resistance values provide the activation energies of Li⁺ transport at the interfacial region (FIGS. 4 C and 4D). The HSCE shows reduced energy barriers for Li⁺ transport through SEI layer (E_{a,SEI}=27.5 kJ mol⁻¹) and Li⁺ desolvation (E_{a,ct}=40.3 kJ mol⁻¹) compared to those of the CVE (E_{a,SEI}=31.2 kJ mol⁻¹ and E_{a,ct}=58.3 kJ mol⁻¹). These values of the CVE are consistent with the previously reported studies. Notably, the Li⁺ desolvation energy barrier decreased much in the HSCE which is known as the most kinetic hindrance process at low temperature operation of the LIBs. These results imply that modified solvation structure and thinner anion-derived SEI layer from the HSCE created a more kinetically favorable interface region than that in the CVE for facile electrochemical reactions at low temperature. Moreover, significantly improved performance of the graphite electrode at high current rates (5 C and 10 C) in the HSCE reinforces the superior Li⁺ reaction kinetics by the HSCE, given that Li⁺ transport rate at the interfacial region has a strong influence on the performance at high current rate as well.

Galvanostatic intermittent titration technique (GITT) analysis also shows improved Li⁺ diffusion in the HSCE. The voltage hysteresis and Ohmic polarization were lower for the HSCE than CVE especially at high lithiation degree (FIG. 4E). This allows facile Li+ reactions into the graphite electrode in the HSCE. The resultant lithium diffusion coefficients (DLi+) in the graphite electrode, were slightly higher in the HSCE (4.99×10⁻¹⁰ cm² s⁻¹ at x=0.3 and 1.84×10⁻¹⁰ cm² s⁻¹ at x=0.7) than CVE (4.79×10⁻¹⁰ cm² s⁻¹ at x=0.3 and 1.31×10⁻¹⁰ cm² s⁻¹ at x=0.7) (FIG. 4F). As the higher lability of the HSCE in MD simulations suggests, there was no Li⁺ transport retardation in the HSCE despite its higher viscosity coming from high concentration. Therefore, the HSCE itself and thin anion-derived SEI layer from the HSCE, containing inorganic species with a larger amount of LiF, led to enhanced overall Li⁺ transport properties without impairing any Li⁺ diffusion process. As a result, the low melting point of THF along with the preferred Li⁺ transport properties of the HSCE boosted the low temperature performance of the LIBs compared with the CVE.

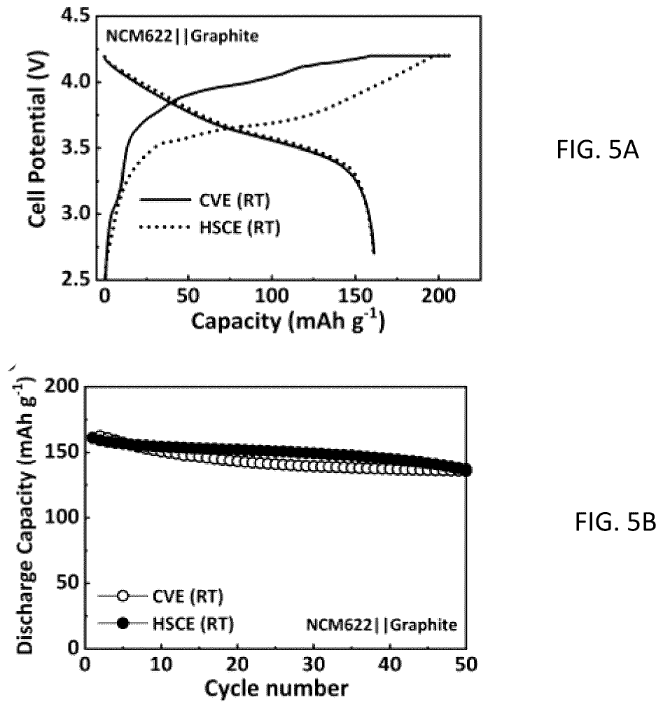

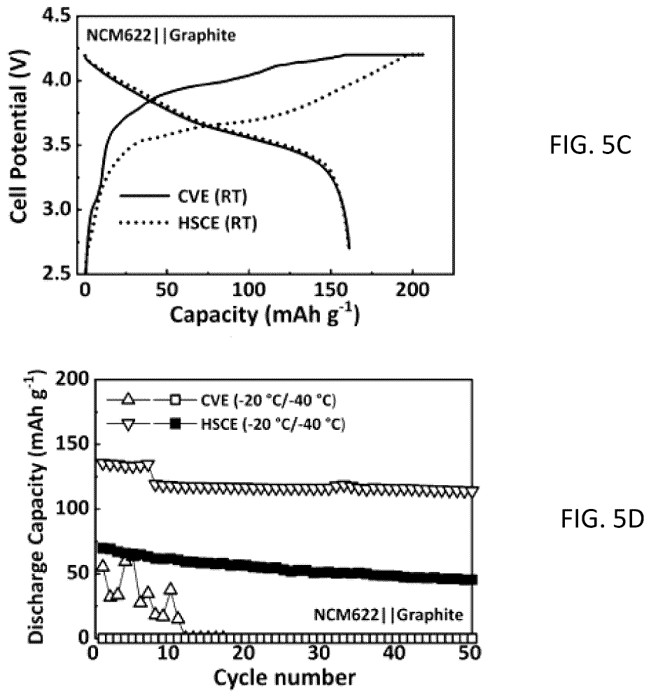

Electrochemical performance of LiNi_{0.6} Co_{0.2}Mn_{0.2}O₂ (NCM622)∥graphite full-cells: The newly developed HSCE also enabled full-cells composed of the NCM622 cathode and graphite anode to achieve enhanced electrochemical performance at room temperature and low temperatures. The full-cells with both electrolytes exhibit similar discharge capacities at the first cycle (CVE: 161.3 mAh g⁻¹ and HSCE: 161.0 mAh g⁻¹) and stable cycling performance at room temperature (FIGS. 5A and 5B). High salt concentration allowed the THF-based HSCE to have oxidation stability beyond 4.2 V (vs. Li/Li′) and be compatible with the high voltage NCM cathode, which otherwise suffered oxidation in the cathode working potential range. Moreover, the overpotential during the first charge was much lower in the HSCE due to the improved Li⁺ transport and distinct SEI formation process from the modified solvation structure and anion-derived SEI layer (FIG. 5A). This effect was more evident at low temperatures by creating a synergy with the low melting point of THF solvent. At −20° C., the full-cell capacity with the HSCE was over 130 mAh g⁻¹ and maintained over 80% capacity retention of the capacity at room temperature, whereas it was only 50 mAh g⁻¹ and showed severe capacity fluctuation with the CVE (FIGS. 5 C and 5D). Moreover, even at −40° C., the full-cell with the HSCE shows 70 mAh g⁻¹ (43% capacity retention) (FIGS. 5 C and 5D). As expected, the capacities decreased at −20 and −40° C. compared to that of at room temperature. However, it generated reasonable electrochemical energy and was rechargeable unlike the full-cell with the CVE, which did not function at all at −40° C.

Thus, in this disclosure is presented a HSCE based on THF solvent and LiFSI salt that achieves an enhanced subzero temperature performance of the LIBs due to its exemplary coordination structure. The Raman spectra obtained for the bulk electrolytes confirmed that the dominating coordination structure of Li⁺ in the HSCE is aggregated ions with FSI⁻. This solvation structure serves as an entirely distinct environment around the cation compared to the case of free ions occurring in typical lower concentration electrolytes. The specific solvation structure of HSCE also participates in producing a thinner but robust LiF-rich anion-derived SEI layer which includes various inorganic compounds on the graphitic anode of LIB. This SEI layer provided the HSCE with great compatibility with the graphite electrode and highly reversible Li⁺ reactions at room temperature leading to remarkably enhanced charge-discharge performances at low temperatures (0° C., −20° C., and −40° C.) compared to that of the conventional electrolytes. Furthermore, the electrochemical analyses that we conducted here demonstrated that Li⁺ transport properties at the interfacial region were improved without degrading any Li⁺ diffusion process in LIBs. Overall, the boosted low temperature performance can attribute to the low melting point of the HSCE and its realization of advanced Li⁺ transport features. The enhanced low temperature performance was successfully implemented to the full-cells composed of NCM622 and graphite electrodes. The HSCE approach of this disclosure provides a new insight for expanding the availability of the LIBs by eliminating the intrinsic limitations of the current LIBs electrolyte system at subzero temperature.

Additional experiments were conducted to establish performance of electrochemical cells with electrolyte-cathode combinations that will be described in this disclosure.

Materials and Methods: Electrolytes were prepared by dissolving a given amount of lithium bis(fluorosulfonyl)imide (LiFSI, Solvionic) salts into the solvent mixture in an Ar-filled glove box. Tetrahydrofuran (THF, Sigma-Aldrich), fluoroethylene carbonate (FEC, TCI America), 1,1,2,2-Tetrafluoroethyl 2,2,3,3-tetrafluoropropyl ether (SynQuest Laborotories) are composed of the solvent mixture. All reagents were high purity (>98%) and used without further purification. Niobium tungsten oxide (NbWO) was synthesized by thermal oxidation of NbO₂ (Alfa Aesar) and WO₂ (Alfa Aesar). NbO₂ and WO₂ were mixed together with a stoichiometric ratio and then pressed into a pallet. The pelletized powder heated at 1200° C. for 24 h in air to obtain NbWO.

Electrochemical measurements: The NbWO electrodes containing NbWO (80 wt %) as an active material, Super P (5 wt %) as a conductive agent, polyvinylidene difluoride (PVDF) (5 wt %) as a binder were prepared onto carbon coated Al foil with a mass loading of 2.5-3.0 mg cm⁻². Cells were assembled using CR2032 coin-type cells with lithium metal as a counter electrode, a polypropylene membrane (Celgard 2500) as a separator and the prepared electrolytes in the Ar-filled glove box. The galvanostatic charge/discharge measurement was carried out using a battery-testing system (Arbin BT-2000) at a voltage range of 1.2 to 3.0 V (vs. Li/Li⁺) at room temperature and −20° C. and 1.0 to 3.0 V (vs. Li/Li′) at −60 and −80° C. Charging (lithiation) and discharging (dilithiation) were performed in a constant current mode. Rate capability tests were carried out with different current rates (1 C to 60 C) at room temperature. For low temperature performance tests, the cells were charged and discharged with the following C-rate at several temperatures (C/5 for −20° C., C/20 for −60° C., and C/100 for −80° C.). Formation cycles were given for the cells at C/5-rate for 5 cycles before all cycling tests. Cyclic voltammetry (CV) was carried out using a potentiostat (Gamry Reference 600+). The CV tests for the NbWO cells were conducted in the potential range between 1.2 and 3.0 V (vs. Li/Li⁺) at several scan rates (0.05 to 2 mV s⁻¹).

Results of above experiments: A modified electrolyte with other type of electrode was tested to achieve further advancement in low temperature performance. The tetrahydrofuran (THF)-based HSCE was diluted with a non-solvating diluent to lower viscosity, thereby increasing ionic conductivity without losing outstanding features of HSCE¹³⁻¹⁵. Niobium tungsten oxide (NbWO) was adopted as an alternative electrode material because its intrinsic open tunnel framework and capacitive charge storage behavior lead to rapid solid-state Li⁺ transport within the material and fast Li⁺ storage at the electrode surface. It would help to circumvent sluggish Li⁺ desolvation and charge transfer which happen in conventional intercalation electrodes.

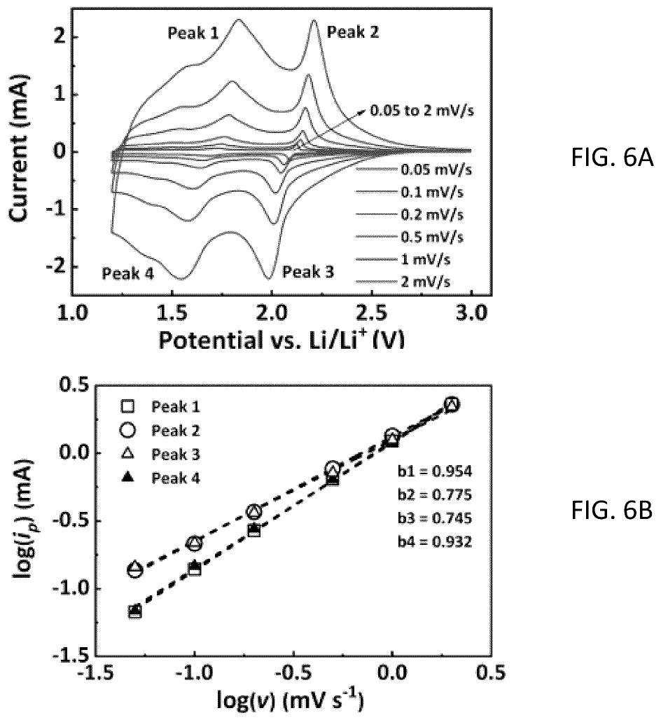

FIG. 6A shows CV curves at different scan rate from 0.05 to 2 mV s⁻¹. The peak current (iₚ) and scan rate (v) of the CV curves generally follow a power law

iₚ=av^{b},

where a and b are adjustable parameters. The relationship between log (iₚ) and log (v) produces the b-values corresponding to the Peak 1 to 4 as shown in FIG. 6B. The b-value indicates which electrochemical reaction is dominant in the cells either diffusion-controlled (b=0.5) or surface-controlled (capacitive, b=1) reactions. For the Peak 1 and 4 related to Nb⁵⁺/Nb⁴⁺ redox reactions, the b-values are close to 1 (0.954 and 0.932, respectively). Meanwhile, the b-values are smaller for the Peak 2 and 3 related to W⁶⁺/W⁵⁺ redox reactions (0.775 and 0.745, respectively). Overall, the b-values reveal that the redox reactions in the NbWO electrode would exhibit pseudocapacitive behavior which can lead to fast Li⁺ storage at the electrode surface by avoiding sluggish Li⁺ desolvation and charge transfer.

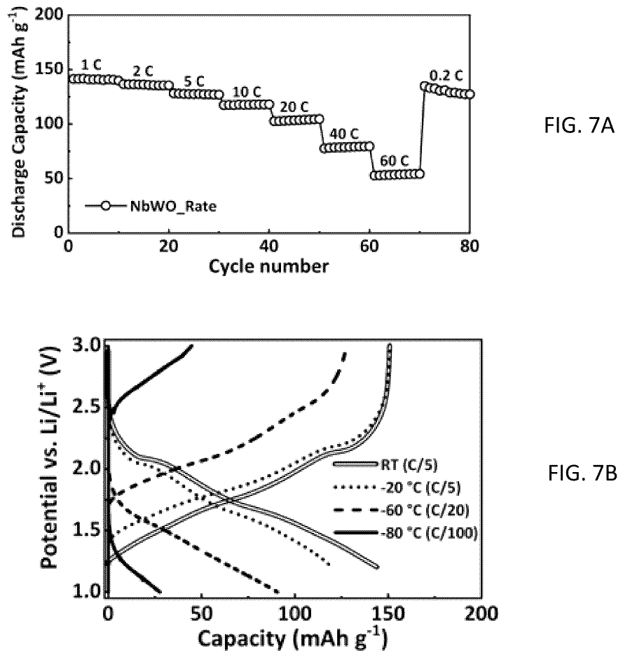

Benefiting from the faster Li⁺ reaction process, the NbWO electrode is able to achieve outstanding rate performance at room temperature, which shows 82% (118 mAh g⁻¹) at 10 C-rate, 72% (104 mAh g⁻¹) at 20 C-rate, 53% (79 mAh g⁻¹) at 40 C-rate, and 33% (54 mAh g⁻¹) at 60 C-rate compared to specific capacity at 1 C (FIG. 7A). Moreover, such efficient Li⁺ reaction kinetics make an enhancement in low temperature battery performance. It exhibits a high capacity of 111 mAh g⁻¹ at −20° C. at 0.2 C-rate with the diluted HSCE (FIG. 7B). Even at ultralow temperatures, the NbWO electrodes are still rechargeable with capacities of 90 mAh g⁻¹ at −60° C. (C/20-rate) and 28 mAh g⁻¹ at −80° C. (C/100-rate).

Based on the above description, it is an objective of this disclosure to describe an electrolyte composition for use is in an electrochemical cell. The electrolyte contains 5 M lithium bis(fluorosulfonyl) imide (LiFSI) dissolved in tetrahydrofuran (THF), wherein the electrolyte has ion-aggregates dominant solvation structures by introducing larger amounts of FSI anions (than found with conventional solid electrolytes), resulting in a thin, inorganic-rich, and less resistive interfacial layer (between anode and electrolyte of the electrochemical cell). It is to be understood that by “less resistive” we mean the thin, inorganic-rich, interfacial layer has resistance less than resistance of an interfacial layer between an anode and a conventional solid electrolyte in an electrochemical cell employing the anode and the conventional solid electrolyte.

In some embodiments of the electrolyte of this disclosure, the interfacial layer thickness from 5 M LiFSI in THF is 3-4.5 nm, which is thinner than an 8-12 nm thick layer from a conventional electrolyte. In some embodiments of the electrolyte composition of this disclosure, the interfacial layer from 5 M LiFSI in THF is composed of various inorganic compounds including LiF, Li₂O, Li₂S, and Li₃N. In some embodiments, the thinner and inorganic-rich interfacial layer form 5 M LiFSI in THF reduces energy barriers for Li cations transport through the layer (27.5 kJ mol⁻¹) and Li cations desolvation (40.3 kJ mol⁻¹) compared to those of the conventional electrolyte (31.2 kJ mol⁻¹ and 58.3 kJ mol⁻¹ respectively).

It is another objective of this disclosure to describe an electrochemical cell. The electrochemical cell of this disclosure contains an anode (one of graphite), a cathode (one of Li metal, LiNi_{0.6} Co_{0.2}Mn_{0.2}O₂), a separator; and an electrolyte comprising LiFSI dissolved in THF, wherein the electrolyte has ion-aggregates dominant solvation structures by introducing larger amounts of FSI anions. In some embodiments of the electrochemical cell of this disclosure, the concentration of LiFSI in THF is 5 M. In some embodiments of the electrochemical of this disclosure, the separator is (celgard (polypropylene). In some embodiments of this disclosure, the electrolyte does not cause Li cation transport retardation within the anode compared to the conventional electrolyte, which lithium diffusion coefficients in the anode are 4.99×10⁻¹⁰ and 1.84×10⁻¹⁰ cm² s⁻¹ at 0.3 and 0.7 lithiation degree respectively (the measured coefficient for conventional electrolyte are 4.79×10⁻¹⁰ and 1.31×10⁻¹⁰ cm² s⁻¹ at 0.3 and 0.7 lithiation degree respectively). In some embodiments of the electrochemical cell of this disclosure, the anode half-cells are rechargeable in the temperature range of −40° C.-25° C. and the discharge capacities are 334, 323, 301, and 84 mAh g⁻¹ at room temperature, 0° C., −20° C., and −40° C. respectively. In some embodiments of the electrochemical cell of this disclosure, the full-cells composed of the anode and cathode are rechargeable in the temperature range of −40° C.-25° C. and the discharge capacities are 161, 130, and 70 mAh g⁻¹ at room temperature, −20° C., and −40° C. respectively.

It is another objective of this disclosure to describe another electrolyte composition for use is in an electrochemical cell. This electrolyte contains Lithium bis(fluorosulfonyl) imide (LiFSI) salt dissolved in tetrahydrofuran (THF), fluoroethylene carbonate (FEC), 1,1,2,2-Tetrafluoroethyl 2,2,3,3-tetrafluoropropyl ether. This electrolyte is capable of being used in an electrochemical cell at −80° C. and lower.

It is another objective of this disclosure to describe another electrochemical cell containing an anode comprising Li metal. a cathode comprising Niobium tungsten oxide, a separator Celgard (polypropylene), and an electrolyte comprising LiFSI dissolved in THF, FEC, and 1,1,2,2-Tetrafluoroethyl 2,2,3,3-tetrafluoropropyl ether. This electrolyte-cathode combination is rechargeable up to −80° C. and lower. In one embodiment of this electrochemical cell, the cell is rechargeable in the temperature range of −80° C. to +25° C. and the discharge capacities are 144, 111, 90, and 28 mAh g⁻¹ at room temperature, −20° C., −60° C., and −80° C., respectively. In some embodiments of the electrochemical of this disclosure, the separator is (celgard (polypropylene)

While the present disclosure has been described with reference to certain embodiments, it will be apparent to those of ordinary skill in the art that other embodiments and implementations are possible that are within the scope of the present disclosure without departing from the spirit and scope of the present disclosure. Thus, the implementations should not be limited to the particular limitations described. Other implementations may be possible. It is therefore intended that the foregoing detailed description be regarded as illustrative rather than limiting. Hence, this disclosure is limited only by the following claims.

1. An electrolyte composition for use is in an electrochemical cell, comprising:
5 M lithium bis(fluorosulfonyl) imide (LiFSI) dissolved in tetrahydrofuran (THF), wherein the electrolyte composition has ion-aggregates dominant solvation structures by introducing larger amounts of FSI anions than found with conventional solid electrolytes, resulting in a thin, inorganic-rich, interfacial layer between anode and electrolyte of an electrochemical cell utilizing the electrolyte composition, wherein the thin, inorganic-rich, interfacial layer has resistance less than resistance of an interfacial layer between an anode and a conventional solid electrolyte in an electrochemical cell employing the anode and the conventional solid electrolyte.

2. The electrolyte composition of claim 1, wherein the interfacial layer thickness from 5 M LiFSI in THF is 3-4.5 nm, which is thinner than an 8-12 nm thick interfacial in an electrochemical cell utilizing a conventional electrolyte.

3. The electrolyte composition of claim 1, wherein the interfacial layer from 5 M LiFSI in THF comprises one or more of inorganic compounds taken from the group consisting of LiF, Li₂O, Li₂S, and Li₃N. The electrolyte composition of claim 1, wherein the thinner and inorganic-rich interfacial layer form 5 M LiFSI in THF reduces energy barriers for Li cations transport through the layer (27.5 kJ mol⁻) and Li cations desolvation (40.3 kJ mol⁻¹) compared to those of the conventional electrolyte.

4. An electrochemical cell comprising:
an anode comprising graphite;
a cathode comprising one of Li metal, LiNi_{0.6} Co_{0.2}Mn_{0.2}O₂;
a separator; and
an electrolyte comprising LiFSI dissolved in THF, wherein the electrolyte has ion-aggregates dominant solvation structures by introducing larger amounts of FSI anions.

5. The electrochemical cell of claim 4, wherein the concentration of LiFSI in THF is 5 M.

6. The electrochemical cell of claim 4, wherein the electrolyte does not cause Li cation transport retardation within the anode compared to the conventional electrolyte, which lithium diffusion coefficients in the anode are 4.99×10⁻¹⁰ and 1.84×10⁻¹⁰ cm² s⁻¹ at 0.3 and 0.7 lithiation degree respectively (the measured coefficient for conventional electrolyte are 4.79×10⁻¹⁰ and 1.31×10⁻¹⁰ cm² s⁻¹ at 0.3 and 0.7 lithiation degree respectively).

7. The electrochemical cell of claim 4, wherein the anode half-cells are rechargeable in the temperature range of −40° C.-25° C. and the discharge capacities are 334, 323, 301, and 84 mAh g⁻¹ at room temperature, 0° C., −20° C., and −40° C. respectively.

8. The electrochemical cell of claim 4, wherein the full-cells composed of the anode and cathode are rechargeable in the temperature range of −40° C.-25° C. and the discharge capacities are 161, 130, and 70 mAh g⁻¹ at room temperature, −20° C., and −40° C. respectively.

9. The electrochemical cell of claim 4, wherein the separator is celgard (polypropylene).

10. An electrolyte composition for use is in an electrochemical cell, comprising:
Lithium bis(fluorosulfonyl) imide (LiFSI) salt dissolved in tetrahydrofuran (THF), fluoroethylene carbonate (FEC), 1,1,2,2-Tetrafluoroethyl 2,2,3,3-tetrafluoropropyl ether wherein the electrolyte is capable of being used in an electrochemical cell at −80° C. and lower.

11. An electrochemical cell encompassing:
an anode comprising Li metal;
a cathode comprising Niobium tungsten oxide;
a separator Celgard (polypropylene); and
an electrolyte comprising LiFSI dissolved in THF, FEC, and 1,1,2,2-Tetrafluoroethyl 2,2,3,3-tetrafluoropropyl ether, wherein the electrolyte-cathode combination is rechargeable up to −80° C. and lower.

12. The electrochemical cell of claim 10, wherein the cell is rechargeable in the temperature range of −80° C. to +25° C. and the discharge capacities are 144, 111, 90, and 28 mAh g⁻¹ at room temperature, −20° C., −60° C., and −80° C., respectively.

13. The electrochemical cell of claim 11, wherein the separator is celgard (polypropylene).
